(19) United States
(12) Patent Application Publication
(10) Pub. No.: US 2009/0192283 A1
(43) Pub. Date: Jul. 30, 2009

(54) PROCESS FOR PREPARING HIGH PERFORMANCE WATERBORNE ALIPHATIC-AROMATIC MIXED POLYURETHANES

(75) Inventors: Shenghong A. DAI, Taichung City (TW); A-Sung CHANG, Taichung City (TW); Tzu-Wen KUO, Taichung City (TW); Chien-wen CHEN, Taichung City (TW)

Correspondence Address: SUGHRUE MION, PLLC, 2100 PENNSYLVANIA AVENUE, N.W., SUITE 800, WASHINGTON, DC, 20037, US

(73) Assignees: Great Eastern Resins Industrial Co., Ltd., Taichung City (TW); National Chung Hsing University, Taichung City (TW)

(21) Appl. No.: 12/357,575

(22) Filed: Jan. 22, 2009

(30) Foreign Application Priority Data
Jan. 25, 2008 (TW) 097102933

(51) Int. Cl. C08G 18/76

(52) U.S. Cl. 528/49; 528/48; 528/51

(57) ABSTRACT

The present invention relates to an improved process for preparing high performance aliphatic-aromatic mixed waterborne polyurethanes (PUs). Waterborne PUs prepared from mixed aromatic diisocyanates and aliphatic diisocyanates exhibit superior mechanical properties as compared with those prepared from aliphatic diisocyanates alone.

### FIELD OF THE INVENTION

The present invention relates to an improved process for preparing high performance aliphatic-aromatic mixed waterborne polyurethanes (WBPUs).

### DESCRIPTION OF THE PRIOR ART

With the increasing awareness of environmental protection, traditional solvent-based PUs have been gradually replaced with waterborne PUs on the grounds that large quantities of organic solvents are wasted in the production and in the application of the former. Even in the preparations of waterborne PUs, the uses of organic solvents in some processes are also becoming an issue, and need to be greatly curtailed. The most common processes for preparing waterborne PUs include a solvent method and a prepolymer method.

The solvent method of waterborne PU preparation comprises the following steps. First, isocyanate functional group-terminated prepolymers can be prepared with molar excess of diisocyanates, long-chain polyols, and short-chain diols with a side chain having hydrophilic groups in an organic solvent to form a pre-polymer solution. This is followed by the addition of a chain extender such as short-chain diols to complete the PU preparation. Water dispersion is carried out under intensively stirring by adding the PU solution to water, and the waterborne PUs are obtained. Because the solvent method utilizes large quantities of solvents to dissolve the resulting high-molecular-weight PUs and then the solvents are recycled by distillation after water-dispersing, the solvents selected must have a boiling point below 100° C. For example, acetone is generally used in the solvent method. However, solvents having a boiling point below 100° C. are flammable and the use of large quantities of such solvents makes the process unsafe. Therefore, in terms of energy conservation, carbon reduction, VOC regulation, and public safety, the solvent method is not an ideal method for preparing waterborne PUs.

The prepolymer method of waterborne PU preparation is different from the previous method in the sequence of the reaction and the mixing. In the first step, isocyanate functional group-terminated prepolymers are prepared similarly to the solvent method. However, the chain extension is delayed until the last step, after the prepolymers were dispersed in water. By doing so, water dispersion can be done without using large quantities of solvents in the process. However, the prepolymer method is mostly limited to use of a few aliphatic diisocyanates with low reactivity (e.g., isophorone diisocyanate (IPDI), 4,4′-dicyclohexylmethane diisocyanate (hydrogenated diphenylmethane diisocyanate, H₁₂MDI), and 3,3,5-trimethyl hexane diisocyanate (3,3,5-TMHDI)). If aromatic diisocyanates (e.g., 4,4′-diphenylmethane diisocyanate (diphenylmethane diisocyanate, MDI), tolylene diisocyanate (TDI), and p-phenylene diisocyanate (PPDI)) are used in the prepolymer method and are added to deionized water, the aromatic diisocyanate will react with water rapidly due to its high reactivity. This will lead to problems such as urea precipitation and foaming, and thereby a stable emulsion cannot be obtained.

Aromatic diisocyanates are very useful chemical materials on the market and have been used as the raw materials of PU polymers for almost sixty years. TDI and MDI are the most common aromatic diisocyanates. Compared with the aliphatic diisocyanates, the unit price of the aromatic diisocyanates is about ¼ to ½ of that of the aliphatic diisocyanates, and the resulting PUs have exhibited overall good mechanical properties. However, the aromatic diisocyanates and water react so fast that the prepolymer method prefers to use aliphatic based prepolymers for better control of dispersion.

To overcome the disadvantage of aromatic diisocyanates in the prepolymer method, U.S. Pat. No. 7,193,011 discloses a method that can replace the aliphatic diisocyanate partially with aromatic ones. In comparison with the conventional prepolymer method, the process modification of the prior art is focused on the preparation of the PU prepolymers, which are synthesized in two steps. More specifically, the method disclosed in the US patent comprises the following steps. First, polyester polyol and dimethylol propionic acid are reacted with aromatic diisocyanates (NCO/OH=0.6) to synthesize OH-terminated prepolymers. Next, aliphatic diisocyanates (NCO/OH=1.2) are added to form aliphatic NCO-terminated prepolymers. The resulting mixed aromatic-aliphatic prepolymers were then dispersed in water. Afterwards, water-soluble chain extenders are used at a normal temperature of 25° C. to prepare waterborne PUs. In order to facilitate the dispersion of the prepolymers in water, N-methyl-pyrrolidone (NMP) having high polarity, high boiling point, and high unit price is used as the solvent for making mixed aromatic-aliphatic prepolymers. However, such procedures are not feasible for commonly used solvents with a low boiling point, low polarity and low unit price, such as butanone. This is because the molecular weight of the prepolymers obtained through this modified prepolymer method is higher than that from the conventional one, in which no aromatic diisocyanates are utilized. Butanone exhibits poorer solubility of such PU prepolymers than NMP. The mixed aromatic-aliphatic prepolymer solution in butanone is much more viscous than that in NMP, and therefore cannot be dispersed in water easily. The obtained aliphatic-aromatic mixed waterborne PUs from butanone also show poor dispersion stability.

In the present invention, the aliphatic-aromatic mixed waterborne PUs are prepared by an improved prepolymer method in one pot. The aliphatic-aromatic mixed PU prepolymers are synthesized only in one step. The aromatic diisocyanates and aliphatic diisocyanates are added to the reactor simultaneously. In addition to simplifying the method described in U.S. Pat. No 7,193,011, the process of the present invention can work with conventionally and commonly used solvents having a low boiling point, such as ketones (butanone), as the solvent to get high performance waterborne PUs. It is unnecessary to use N-methyl-pyrrolidone with high polarity and high boiling point.

### SUMMARY OF THE INVENTION

The present invention is directed to an improved process for preparing high performance aliphatic-aromatic mixed waterborne PUs.

In the present invention, aliphatic-aromatic mixed waterborne PUs are prepared through a prepolymer method. The aliphatic-aromatic mixed PU prepolymers are synthesized by taking advantage of the reactivity difference between aromatic and aliphatic isocyanate (NCO) groups. Aromatic NCO is well-known for its high reactivity. In the reaction of NCO toward hydroxyl (OH) groups, aromatic urethane is formed generally in quantitative yield under a mild condition. Furthermore, the reaction of aromatic diisocyanates with OH groups is significantly faster than that of aliphatic ones. When aromatic diisocyanates and aliphatic diisocyanates are put together to synthesize isocyanate-terminated prepolymers with di-hydroxyl compounds, the majority of the aromatic diisocyanates would be consumed first to form PU prepolymers preferentially bearing interior aromatic bis-urethane building blocks; meanwhile the co-existing less reactive aliphatic diisocyanates would act as diluting solvents and molecular weight regulators. The probability of chain extension will be reduced once the aliphatic diisocyanates is connected to the prepolymer chain terminals. By this general formulation design and one-shot method, a PU prepolymer solution having low molecular weight, low viscosity and capable of being dissolved in a small quantity of common solvents with low boiling points, such as acetone or butanone, is found. In addition, the chain ends of the PU prepolymer would be aliphatic NCO groups in major. This type of isocyanate-functionalized PU prepolymer could be easily dispersed into water and chain-extended by diamines in the aqueous dispersion. Eventually, a stable aliphatic-aromatic mixed PUs emulsion is obtained.

The present invention provides a process for preparing high performance aliphatic-aromatic mixed waterborne PUs comprising:

(1) mixing a hydrophilic component, a long-chain polyol, and a water-soluble solvent with a boiling point of between 50° C. and 80° C. to form a mixture and adding an aromatic diisocyanate and an aliphatic diisocyanate to the mixture simultaneously to form prepolymers, wherein the equivalent ratio of NCO/OH functional groups is 1.6-3.0 and the aromatic diisocyanate is about 5 to 50 mol % of the total amount of the diisocyanates, preferably about 10 to 40 mol %;

(2) adding a neutralizing agent to the prepolymers of (1);

(3) carrying out water dispersion;

(4) optionally adding a cross-linking agent; and

(5) adding a diamine chain extender to prepare the waterborne PUs.

The reaction time is adjustable depending on the reactants and reaction procedures and conditions. Generally, the reaction time is about 1.5 to 6 hours, and preferably about 2 to 4 hours.

According to the process mentioned above, the equivalent ratio of NCO/(OH+NH₂) functional groups is 1-1.3.

The solvent used in the present invention is preferably a ketone, and more preferably butanone.

The long-chain polyols used in the present invention can include, but are not limited to, the group consisting of esters, ethers, carbonates, siloxanes, alkenes, and mixtures thereof, and the long-chain polyols have a number average molecular weight of 600-4,000 g/mole and a number of functional groups of 2.

The hydrophilic components used in the present invention include, but are not limited to, the group consisting of carboxylic acids or carboxylates, sulphonic acids or sulfonates, phosphoric acids or phosphates, chain segments of polyvinyl ether, and mixtures thereof. More particularly, said hydrophilic components can include, but are not limited to, the group consisting of dimethyl propionic acid (DMPA), dimethyl butyric acid (DMBA), N-(2-hydroxyethyl) taurine monosodium salt, sodium 1,4-butanediol-2-sulfonate, polyvinyl ether sulfonate diamine, polyvinyl ether sulfonate diol, and mixtures thereof.

The aromatic diisocyanate used in the present invention can include, but is not limited to, the group consisting of MDI, TDI, p-phenylene diisocyanate (PPDI), and mixtures thereof.

The aliphatic diisocyanate used in the process of the present invention can include, but is not limited to, the group consisting of hydrogenated diphenylmethane diisocyanate (H₁₂MDI), isophorone diisocyanate (IPDI), 1,6-hexane diisocyanate (HDI), 1,6-hexane diisocyanate dimer (HDI dimer), xylylene diisocyanate (XDI), α,α,α′,α′-tetramethylxylylene diisocyanate (TMXDI), trimethyl hexane diisocyanate (TMHDI), and mixtures thereof.

The neutralizing agent used in the present invention is selected from the group consisting of triethyl amine, ammonium hydroxide, sodium hydroxide, potassium hydroxide, and mixtures thereof.

The chain extender used in the present invention is selected from the group consisting of ethylene diamine (EDA), butylene diamine (BDA), hexylene diamine (HDA), isophorone diamine (IPDA), p-phenylene diamine (pPDA), m-xylylene-α,α′-diamine (mXDA), p-xylylene-α,α′-diamine (pXDA), oligo(alkylene)ether diamine with a molecular weight of 100-250, 1,4-cyclohexanedimethanamine, 1,3-cyclohexanedimethanamine, meta-phenylenediamine (mPDA), trans/cis-(1,4-cyclohexanediamine), [R,S]/[R,R]-(1,3-cyclohexanediamine), trans-(4-aminomethyl-1-cyclohexanamine), 3-(aminomethyl)cyclohexylamine, 2,5-norbornanebis(methylamine), 2,6-norbornanebis(methylamine), and mixtures thereof. The oligo(alkylene)ether diamine contains repeat units and alkyl amine end groups. The repeat units can include, but are not limited to, the group consisting of oxyethylene, oxypropylene, oxybutylene, and mixtures thereof. The alkyl amine end groups can include, but are not limited to, the group consisting of ethylene amine, propylene amine, butylene amine, and mixtures thereof.

The oligo(alkylene)ether diamine with a molecular weight of 100-250, which is the chain extender, can include, but is not limited to, the group consisting of ethylene glycol bis(2-aminoethyl)ether(triethylene glycol diamine, CAS#929-59-9), diethylene glycol bis(2-aminoethyl)ether(tetraethylene glycol diamine), diethylene glycol dipropyl amine [CAS 194673-87-5], Jeffamine® KH-511, Jeffamine® EDR-148, Jeffamine® EDR-192, Jeffamine® D230, and mixtures thereof. In addition, when the reactivity of the aliphatic diisocyanate is better, the chain extension between latex particles in the emulsion can be reduced by changing the addition method of the chain extender, and therefore the dispersion stability of the waterborne PUs is enhanced. The addition method of the chain extender includes, but is not limited to, syringe injection, dropwise addition after diluting with water or the above-mentioned common solvents.

The equivalent ratio of the hydrophilic component to the neutralizing agent used in the present invention is 0.9-1.1.

The temperature for water dispersion in the process of the present invention is about 20 to 50° C., depending on the aliphatic diisocyanates used. When H₁₂MDI is used, the maximum acceptable temperature for successful water dispersion is about 50° C. However, if the aliphatic diisocyanates are 1,6-hexane diisocyanate (HDI) and isophorone diisocyanate (IPDI), after the addition of water into the prepolymers, the number of bubbles increases suddenly at the outlet of the reactor, which indicates that the remainder of NCO functional groups in the emulsifying process are reacted with water. Consequently, it is not easy to prepare stably dispersed waterborne PUs at such a high water-dispersing temperature of 50° C. In the present invention, it is found that the water dispersion of the prepolymers obtained by using IPDI can be smoothly carried out at about 30° C. to 40° C. The IPDI-based prepolymers and EDA can carry out chain extension at last to form a stable emulsion. Moreover, the prepolymers obtained by using HDI should be dispersed in water at about 20° C. to 30° C. for obtaining a stable water dispersion of HDI-based prepolymer. In addition, the water-soluble chain extender EDA should be replaced with hydrophobic IPDA in order to form a more stable emulsion.

In the present invention, it is also found that if the amount of the aromatic diisocyanate in the total amount of the diisocyanates is more than 50 mol %, the remaining aromatic diisocyanate in the PU prepolymer will react immediately with the added water during water dispersing, and eventually result in an unevenly dispersed emulsion. Therefore, the aromatic diisocyanate can be 5 to 50 mol % of the total amount of the diisocyanates, and preferably 10 to 40 mol %.

The cross-linking agent used in the present invention is an amine having three functional groups. The amino equivalent of the cross-linking agent is 3% to 25% of the total amino equivalent.

In the present invention, in addition to the above steps, the synthesis of the prepolymers can include reacting the hydrophilic component with the mixture of aliphatic-aromatic diisocyanates first and then adding long-chain polyols to synthesize the isocyanate-terminated prepolymers, or reacting long-chain polyols with the mixture of aliphatic-aromatic diisocyanates first, and then adding the hydrophilic component. Anyhow, when synthesizing the prepolymers, the aromatic diisocyanate and the aliphatic diisocyanate must be added at the same reaction stage.

Compared with U.S. Pat. No. 7,193,011, the present invention has the following advantages: (1) The process is simpler because the aliphatic diisocyanate and the aromatic diisocyanate are added in the same step; (2) As the reactivity of aromatic diisocyanates to hydroxyl group (OH) is significantly higher than that of the aliphatic diisocyanates to hydroxyl group, when the aromatic diisocyanates and the aliphatic diisocyanates are simultaneously used to synthesize isocyanate-terminated prepolymers, the majority of the aromatic diisocyanates will first react with the hydroxyl compounds to form prepolymers while the co-existing aliphatic diisocyanates act as diluting solvents; (3) Once either end of the prepolymer molecular chain and the aliphatic diisocyanate are joined together, the end will inhibit the chain extension due to deteriorated reactivity, thus preventing from the generation of prepolymers having too high molecular weights; (4) Water dispersion and chain extension can be subsequently completed by a one-pot process directly, or water dispersion and chain extension can also be completed by adding the prepolymers to water; (5) U.S. Pat. No. 7,193,011 needs to use N-methyl-pyrrolidone of high unit price, high polarity, high boiling point (202° C.), and high solubility as the solvent to prevent the prepolymers from gelation due to high molecular weights. Since the molecular weights of the prepolymers of the present invention can be properly controlled and the majority of the aliphatic diisocyanates act as diluting solvents, a ketone solvent with low unit price, moderate polarity, low boiling point, and moderate solubility, preferably butanone (MEK, boiling point of 78° C. at normal pressure), can be used to form a prepolymer solution with relatively low viscosity. Furthermore, when the process of the present invention is scaled up for mass production, the low boiling point solvents can be conveniently recycled.

### DETAILED DESCRIPTION OF THE INVENTION

The details of the present invention are further described with reference to the embodiments below. Such description is not intended to limit the scope of the present invention. Any modifications and changes made by those skilled in the art without departing the spirit of the present invention will fall within the scope of the present invention.

The implementation of the present invention is illustrated by the specific embodiments in the following.

The raw materials include 4,4′-diphenylmethane diisocyanate (MDI), 4,4′-dicyclohexylmethane diisocyanate (H₁₂MDI), isophorone diisocyanate (IPDI), 1,6-hexane diisocyanate (HDI), dimethyl propionate (DMPA), poly(ethylene butylene adipate)diol (referred to as PEBA-2000, number average molecular weight of about 2,000), poly(tetramethylene ether)glycol (referred to as PTMEG-2000, number average molecular weight of about 2,000), butanone (MEK), triethylamine (TEA), ethylene diamine (EDA), butylene diamine (BDA), isophorone diamine (IPDA), m-xylylene-α,α′-diamine (m-XDA), Jeffamine® EDR-192, Jeffamine® HK-511, and the cross-linking agent with triamino (Jeffamine® T403), in which PEBA-2000 and PTMEG-2000 must be degassed and the pressure thereof must be reduced at 110-130° C. for about 4-5 hours prior to use, DMPA must be dried and the pressure thereof must be reduced at 80° C. for about 4 hours, MDI, H₁₂MDI, MEK, EDA, and TEA must be distilled prior to use, and BDA, IPDA, m-XDA, EDR-192, HK-511, and T403 can be used as received.

Test Method of Physical Properties:
1. Particle size: The particle size is measured at 25° C. by BIC Co.BI-90 Plus from Brookhaven Instruments Corp.
2. Mechanical properties: The mechanical properties are tested with Computer Universal Material Tester HT-8504 from HungTa Instrument Corp., Ltd.

Preparation of Aliphatic-Aromatic Mixed Waterborne PUs With H₁₂MDI/MDI

### EXAMPLE 1

A 500 mL separate type reactor and a mechanical stirrer (cooled by cooling water of 5° C. outside the reactor) were used and filled with nitrogen, and DMPA (5.36 g), PEBA-2000 (60.02 g), and MEK (20 wt % of the total weight of the prepolymers) were added to the reactor and stirred at 50° C. for 30 minutes (a rotation rate of about 120-180 rpm). Next, MDI (12.77 g) and H₁₂MDI (24.44 g) were simultaneously added to the reactor, the temperature was raised to 75° C., and the stirring was continued for 4 hours (NCO/OH=2.06). Then, the temperature was reduced to 50° C. After the addition of a neutralizing agent TEA (with the same equivalent as that of COOH group) and stirring for 30 minutes, deionized water was added to the reactor to carry out water dispersion (at a rotation rate of about 600-900 rpm). After water dispersion, EDA (4.40 g) was added to the reactor with a syringe to carry out chain extension for 30 minutes (NCO/(OH+NH₂)=1.00). Aliphatic-aromatic mixed waterborne PUs with a solid content of 30% were obtained.

### COMPARABLE EXAMPLE C1

Aliphatic-aromatic mixed waterborne PUs were synthesized according to the two-step process disclosed in U.S. Pat. No. 7,193,011. A 500 mL separate type reactor and a mechanical stirrer (cooled by cooling water of 5° C. outside the reactor) were used and filled with nitrogen, and DMPA (5.36 g), PEBA-2000 (60.03 g), and MEK (25.49 g) were added to the reactor and stirred at 50° C. for 30 minutes (at a rotation rate of about 120-180 rpm). Next, MDI (12.72 g) was added to the reactor to carry out the reaction at 75° C. and the reaction was monitored with IR until NCO (2270 cm⁻¹) was exhausted. OH-terminated prepolymers were obtained. Then, H₁₂MDI (24.42 g) (NCO/OH=2.06) was added to the reactor to form NCO-terminated prepolymers. Afterwards the temperature was reduced to 50° C. After the addition of a neutralizing agent TEA (4.10 g) and stirring for 30 minutes, deionized water was added to the reactor to carry out water dispersion (at a rotation rate of about 600-900 rpm). After water dispersion, EDA (4.38 g) was added to the reactor with a syringe to carry out chain extension for 30 minutes (NCO/(OH+NH₂)=1.01). Aliphatic-aromatic mixed waterborne PUs with a solid content of 30% were obtained.

### COMPARABLE EXAMPLE C2

The process in Comparable Example C1 was repeated with the following quantities of raw materials:

DMPA (5.36 g), PEBA-2000 (60.08 g);

NMP (25.00 g) substituted for MEK;

MDI (12.77 g), H₁₂MDI (24.45 g) (NCO/OH=2.06);

TEA (4.06 g), EDA (4.38 g) (NCO/(OH+NH₂)=1.00).

The constituent equivalent ratios, particle size and tensile property of Example 1 and Comparable Examples C1 and C2 are listed in Table 1. Stable dispersed aliphatic-aromatic mixed waterborne PUs can be obtained by the one-step addition of the aliphatic diisocyanate and the aromatic diisocyanate of the present invention. However, a paste product with high viscosity is obtained by the two-step addition method of U.S. Pat. No. 7,193,011. Moreover, through the method of the present invention, a stable aqueous dispersion can be obtained by using MEK, which is inexpensive and used widely. However, a stable aqueous dispersion cannot be obtained through the method of U.S. Pat. No. 7,193,011. Consequently, the present invention is superior to U.S. Pat. No. 7,193,011.

TABLE 1

| | Addition | | | | | | | | | |
|---|---|---|---|---|---|---|---|---|---|---|
| Example/ | method of | | Long- | Diamine | | | | | | |
| Comparable | diisocyanates | Aliphatic | chain | chain | Aliphatic | Aromatic | | | Iso | MDI |
| Example | (solvent) | diisocyanate | polyol | extender | NCO | NCO^{a} | OH | NH₂ | index^{b} | mol %^{c} |
| 1 | one shot | H₁₂MDI | RS-956 | EDA | 1.33 | 0.73 | 1.00 | 1.05 | 1.01 | 35.4 |
| | (MEK) | | | | | | | | | |
| C1 | two steps | H₁₂MDI | RS-956 | EDA | 1.33 | 0.73 | 1.00 | 1.04 | 1.01 | 35.3 |
| | (MEK) | | | | | | | | | |
| C2 | two steps | H₁₂MDI | RS-956 | EDA | 1.33 | 0.73 | 1.00 | 1.04 | 1.01 | 35.4 |
| | (NMP) | | | | | | | | | |

| | Addition method of | | Tensile | 100% | |
|---|---|---|---|---|---|
| Example/Comparable | diisocyanates | Particle | strength | Modulus | Elongation |
| Example | (solvent) | size (nm) | (MPa) | (MPa) | (%) |
| 1 | one shot (MEK) | 66 | 22.85 | 6.2 | 380 |
| C1 | two steps (MEK) | Paste | 23.52 | 4.8 | 442 |
| C2 | two steps (NMP) | | 36.5 | 6.7 | 526 |

^{a}Aromatic diisocyanate: MDI
^{b}Iso index = (aliphatic NCO + aromatic NCO)/(OH + NH₂)
^{c}MDI mol % = aromatic NCO/(aliphatic NCO + aromatic NCO)

### EXAMPLE 2

The process in Example 1 was repeated with the following quantities of raw materials:

DMPA (5.35 g), PEBA-2000 (60.00 g);

MEK (26.75 g);

MDI (3.75 g), H₁₂MDI (33.84 g) (NCO/OH=2.06);

TEA (4.03 g), EDA (4.45 g) (NCO/(OH+NH₂)=1.00).

### EXAMPLE 3

The process in Example 2 was repeated except the respective quantity of MDI and H₁₂MDI was changed to the following:

MDI (9.53 g), H₁₂MDI (27.78 g).

### EXAMPLE 4

The process in Example 2 was repeated except the respective quantity of MDI and H₁₂MDI was changed to the following:

MDI (12.76 g), H₁₂MDI (24.39 g).

### COMPARABLE EXAMPLE C3

The process in Example 2 was repeated except that MDI was not added:

H₁₂MDI (37.77 g) (NCO/OH=2.06), catalyst T9 (0.52 g).

### EXAMPLE 5

### Reduction of the Quantity of EDA

The process in Example 4 was repeated except that the quantity of EDA was changed to 3.34 g.

### EXAMPLE: 6

### Addition of T403

The process was substantially the same as that in Example 4 except that after the step of water dispersion, T403 (2.58 g) was used to replace a portion of EDA, and then EDA was used (3.87 g) [molar percent: T403/(EDA+T403)=9 mol %].

### EXAMPLE 7

The process in Example 4 was repeated except that PTMEG-2000 (60.00 g) was used to replace PEBA-2000 and m-XDA was used to replace EDA (10.09 g, which was dissolved in water first and dropped into the aqueous dispersion of the prepolymers).

TABLE 2

| Example/ | | | Diamine | | | | | |
|---|---|---|---|---|---|---|---|---|
| Comparable | Aliphatic | Long-chain | chain | Aliphatic | Aromatic | | | Iso |
| Example | diisocyanate | diol | extender | NCO | NCO | OH | NH₂ | index |
| C3 | H₁₂MDI | RS-956 | EDA | 2.06 | 0.00 | 1.00 | 1.06 | 1.00 |
| 2 | H₁₂MDI | RS-956 | EDA | 1.85 | 0.21 | 1.00 | 1.06 | 1.00 |
| 3 | H₁₂MDI | RS-956 | EDA | 1.52 | 0.54 | 1.00 | 1.06 | 1.00 |
| 4 | H₁₂MDI | RS-956 | EDA | 1.33 | 0.73 | 1.00 | 1.06 | 1.00 |
| 5 | H₁₂MDI | RS-956 | EDA | 1.33 | 0.73 | 1.00 | 0.80 | 1.15 |
| 6 | H₁₂MDI | RS-956 | T403/EDA | 1.33 | 0.73 | 1.00 | 0.14/0.92 | 1.00 |
| 7 | H₁₂MDI | PTMEG-2000 | m-XDA | 1.33 | 0.73 | 1.00 | 1.06 | 1.00 |

| | | | Tensile | 100% | |
|---|---|---|---|---|---|
| Example/Comparable | MDI | Particle | strength | Modulus | Elongation |
| Example | mol % | size (nm) | (MPa) | (MPa) | (%) |
| C3 | 0.0 | 45 | 20 | 6.6 | 332 |
| 2 | 10.4 | 40 | 19 | 6.4 | 325 |
| 3 | 26.4 | 85 | 24 | 6.0 | 370 |
| 4 | 35.4 | 102 | 23 | 6.2 | 380 |
| 5 | 35.4 | 110 | 30 | 6.3 | 418 |
| 6 | 35.4 | 90 | 29 | 6.4 | 383 |
| 7 | 35.4 | 142 | 31 | 13.3 | 242 |

The constituent equivalent ratios, particle size and tensile property of Examples 2-5 and Comparable Example C3 are listed in Table 2. A comparison between Examples 2-4 and Comparable Example C3 shows that adding MDI to replace a portion of H₁₂MDI reduces 100% modulus strength by 9% at most and can increase the tensile strength by 20% at most.

Preparation of Aliphatic-Aromatic Mixed Waterborne PUs With IPDI/MDI

### EXAMPLE 8

The process was substantially the same as that in Example 1, in which the stirring time of the prepolymers was reduced to 3 hours and the temperature was reduced to 35° C. before water dispersion. H₁₂MDI was replaced with IPDI so that the amount of MDI was changed. EDA was dissolved into water first and was dropped into the aqueous dispersion of the prepolymers.

MDI (3.38 g), IPDI (28.97 g).

### EXAMPLE 9

The process in Example 6 was repeated except the respective quantity of MDI and H₁₂MDI was changed to the following:

MDI (8.26 g), IPDI (24.64 g).

### EXAMPLE 10

The process in Example 6 was repeated except the respective quantity of MDI and H₁₂MDI was changed to the following:

MDI (12.76 g), IPDI (20.65 g).

### COMPARABLE EXAMPLE C4

The process in Example 6 was repeated excepted that MDI was not added:

IPDI (31.97 g), catalyst T9 (0.49 g).

### EXAMPLE 11

The process in Example 6 was repeated with the following modifications:

DMPA (4.82 g), PTMEG-2000 (60.00 g) substituted for PEBA-2000;

MDI (16.52 g), IPDI (17.32 g);

EDA (4.68 g).

### EXAMPLE 12

The process in Example 9 was repeated with the following modifications:

DMPA (5.35 g);

MDI (12.76 g), IPDI (20.65 g);

BDA (6.53 g) substituted for EDA.

### EXAMPLE 13

The process in Example 9 was repeated with the following modifications:

DMPA (5.60 g);

MDI (10.34 g), IPDI (17.03 g);

EDR-192 (8.88 g) substituted for EDA.

### EXAMPLE 14

The process in Example 9 was repeated with the following modifications:

DMPA (5.34 g);

MDI (9.85 g), IPDI (16.23 g);

HK-511 (9.38 g) substituted for EDA.

### EXAMPLE 15

The process in Example 9 was repeated with the following modifications:

DMPA (4.36 g);

MDI (8.76 g), IPDI (14.43 g);

IPDA (4.79 g) substituted for EDA.

TABLE 3

| Example/ | | | Diamine | | | | | |
|---|---|---|---|---|---|---|---|---|
| Comparable | Aliphatic | Long-chain | chain | Aliphatic | Aromatic | | | Iso |
| Example | diisocyanate | diol | extender | NCO | NCO | OH | NH₂ | index |
| C4 | IPDI | RS-956 | EDA | 2.06 | 0.00 | 1.00 | 1.06 | 1.00 |
| 8 | IPDI | RS-956 | EDA | 1.86 | 0.19 | 1.00 | 1.06 | 1.00 |
| 9 | IPDI | RS-956 | EDA | 1.59 | 0.47 | 1.00 | 1.06 | 1.00 |
| 10 | IPDI | RS-956 | EDA | 1.33 | 0.73 | 1.00 | 1.06 | 1.00 |
| 11 | IPDI | PTMEG-2000 | EDA | 1.18 | 1.00 | 1.00 | 1.18 | 1.00 |
| 12 | IPDI | PTMEG-2000 | BDA | 1.33 | 0.73 | 1.00 | 1.06 | 1.00 |
| 13 | IPDI | PTMEG-2000 | EDR-192 | 1.07 | 0.58 | 1.00 | 0.64 | 1.00 |
| 14 | IPDI | PTMEG-2000 | HK-511 | 1.05 | 0.56 | 1.00 | 0.61 | 1.00 |
| 15 | IPDI | PTMEG-2000 | IPDA | 1.04 | 0.56 | 1.00 | 0.45 | 1.10 |

| | | | Tensile | 100% | |
|---|---|---|---|---|---|
| Example/Comparable | MDI | Particle | strength | Modulus | Elongation |
| Example | mol % | size (nm) | (MPa) | (MPa) | (%) |
| C4 | 0.0 | 53 | 19 | 4.0 | 507 |
| 8 | 9.4 | 40 | 19 | 3.9 | 473 |
| 9 | 22.9 | 73 | 24 | 4.1 | 511 |
| 10 | 35.4 | 83 | 28 | 5.9 | 447 |
| 11 | 45.9 | 165 | 25 | 5.5 | 431 |
| 12 | 35.4 | 163 | 28 | 5.9 | 413 |
| 13 | 35.0 | 127 | 26 | 1.85 | 1039 |
| 14 | 35.0 | 179 | 27 | 2.79 | 731 |
| 15 | 35.0 | 111 | 28 | 4.2 | 523 |

A comparison between Examples 8-10 and Comparable Example C4 shows that adding MDI to replace a portion of IPDI can increase 100% modulus strength by 48% at most and the tensile strength by 47% at most.

Preparation of Aliphatic-Aromatic Mixed Waterborne PUs With HDI/MDI

### EXAMPLE 16

The process was substantially the same as that in Example 1, in which the stirring time of the prepolymers was reduced to 2 hours and the temperature was reduced to 20° C. before water dispersion. H₁₂MDI was replaced with HDI and EDA was replaced with IPDA (12.60 g). IPDA was diluted with 6.3 g MEK first and dropped into the aqueous dispersion of the prepolymers. The quantities of MDI and HDI were as follows:

MDI (2.55 g), HDI (22.48 g).

### EXAMPLE 17

The process in Example 16 was repeated except the respective quantity of MDI and HDI was changed to the following:

MDI (6.61 g), HDI (19.76 g).

### EXAMPLE 18

The process in Example 16 was repeated except the respective quantity of MDI and HDI was changed to the following:

MDI (9.57 g), HDI (17.77 g).

### COMPARABLE EXAMPLE C5

The process in Example 16 was repeated except that MDI was not added:

HDI (24.19 g), catalyst T9 (0.45 g).

### EXAMPLE 19

The process in Example 16 was repeated except that PEBA-2000 was replaced with PTMEG-2000 (60.00 g). The quantities of MDI and HDI were as follows:

MDI (2.55 g), HDI (22.48 g);

### EXAMPLE 20

The process in Example 19 was repeated except the respective quantity of MDI and HDI was changed to the following:

MDI (6.61 g), HDI (19.76 g).

### EXAMPLE 21

The process in Example 19 was repeated except the respective quantity of MDI and HDI was changed to the following:

MDI (9.57 g), HDI (17.77 g).

### EXAMPLE 22

The process in Example 19 was repeated except the respective quantity of MDI and HDI was changed to the following:

MDI (12.76 g), HDI (15.62 g).

### COMPARABLE EXAMPLE C6

The process in Example 19 was repeated except that MDI was not added:

HDI (24.19 g), catalyst T9 (0.45 g).

TABLE 4

| Example/ | | | Diamine | | | | | |
|---|---|---|---|---|---|---|---|---|
| Comparable | Aliphatic | Long-chain | chain | Aliphatic | Aromatic | | | Iso |
| Example | diisocyanate | diol | extender | NCO | NCO | OH | NH₂ | index |
| C5 | HDI | RS-956 | IPDA | 2.06 | 0.00 | 1.00 | 1.06 | 0.00 |
| 16 | HDI | RS-956 | IPDA | 1.91 | 0.15 | 1.00 | 1.06 | 1.00 |
| 17 | HDI | RS-956 | IPDA | 1.68 | 0.38 | 1.00 | 1.06 | 1.00 |
| 18 | HDI | RS-956 | IPDA | 1.51 | 0.55 | 1.00 | 1.06 | 1.00 |
| C6 | HDI | PTMEG-2000 | IPDA | 2.06 | 0.00 | 1.00 | 1.06 | 1.00 |
| 19 | HDI | PTMEG-2000 | IPDA | 1.91 | 0.15 | 1.00 | 1.06 | 1.00 |
| 20 | HDI | PTMEG-2000 | IPDA | 1.68 | 0.38 | 1.00 | 1.06 | 1.00 |
| 21 | HDI | PTMEG-2000 | IPDA | 1.51 | 0.55 | 1.00 | 1.06 | 1.00 |
| 22 | HDI | PTMEG-2000 | IPDA | 1.33 | 0.73 | 1.00 | 1.06 | 1.00 |

| | | | | 100% | |
|---|---|---|---|---|---|
| Example/Comparable | MDI | Particle size | Tensile | Modulus | Elongation |
| Example | mol % | (nm) | strength (MPa) | (MPa) | (%) |
| C5 | 0.0 | 120 | 17 | 4.3 | 495 |
| 16 | 7.1 | 132 | 28 | 4.9 | 518 |
| 17 | 18.4 | 132 | 20 | 4.9 | 424 |
| 18 | 26.6 | 106 | 26 | 6.8 | 440 |
| C6 | 0.0 | 137 | 24 | 3.4 | 712 |
| 19 | 7.1 | 132 | 26 | 5.2 | 518 |
| 20 | 18.4 | 131 | 23 | 5.4 | 498 |
| 21 | 26.6 | 150 | 27 | 5.8 | 408 |
| 22 | 35.4 | 113 | 23 | 6.3 | 354 |

A comparison between Examples 16-18 and Comparable Example C5 shows that adding MDI to replace a portion of HDI can increase 100% modulus strength by 58% at most and tensile strength by 65% at most.

A comparison between Examples 19-22 and Comparable Example C6 shows that adding MDI to replace a portion of HDI can increase 100% modulus strength by85% at most and tensile strength by 13% at most.

While the claims below are intended to define the reasonable protection scope of the present invention, any obvious modifications achieved by those of ordinary skill in the art on the basis of the disclosure of the present invention also fall within the reasonable protection scope of the present invention.

We claim:

1. A process for preparing waterborne polyurethanes (PUs) comprising:
(1) mixing a hydrophilic component, a long-chain polyol, and a water-soluble solvent with a boiling point between 50° C. and 80° C. to form a mixture, and adding an aromatic diisocyanate and an aliphatic diisocyanate to the mixture simultaneously to form prepolymers, wherein the equivalent ratio of NCO/OH functional group is 1.6-3.0 and the aromatic diisocyanate is about 5 to 50 mol % of the total amount of the diisocyanates;
(2) adding a neutralizing agent to the prepolymers of (1);
(3) carrying out water dispersion;
(4) optionally adding a cross-linking agent; and
(5) adding diamine chain extender to prepare the waterborne PUs.

2. The process as claimed in claim 1, wherein the equivalent ratio of NCO/(OH+NH₂) functional group is 1-1.3.

3. The process as claimed in claim 1, wherein the solvent is capable of being recycled by distillation.

4. The process as claimed in claim 1, wherein said solvent is a ketone.

5. The process as claimed in claim 4, wherein said solvent is butanone.

6. The process as claimed in claim 1, wherein said long-chain polyol is selected from the group consisting of esters, ethers, carbonates, silicones, alkenes, and mixtures thereof.

7. The process as claimed in claim 6, wherein said long-chain polyol has a number average molecular weight of 600-4,000 g/mole and a number of functional groups of 2.

8. The process as claimed in claim 1, wherein said hydrophilic component has a functional group selected from the group consisting of carboxylic acids or carboxylates, sulphonic acids or sulfonates, phosphoric acids or phosphates, chain segments of polyvinyl ether, and mixtures thereof.

9. The process as claimed in claim 1, wherein said hydrophilic component is selected from the group consisting of dimethyl propionic acid (DMPA), dimethyl butyric acid (DMBA), N-(2-hydroxyethyl) taurine monosodium salt, sodium 1,4-butanediol-2-sulfonate, polyvinyl ether sulfonate diamine, polyvinyl ether sulfonate diol, and mixtures thereof.

10. The process as claimed in claim 1, wherein said aromatic diisocyanate is selected from the group consisting of diphenylmethane diisocyanate (MDI), toluene diisocyanate (TDI), p-phenylene diisocyanate (PPDI), and mixtures thereof.

11. The process as claimed in claim 1, wherein said aliphatic diisocyanate is selected from the group consisting of 4,4′-dicyclohexylmethane diisocyanate (hydrogenated diphenylmethane diisocyanate, H₁₂MDI), isophorone diisocyanate (IPDI), 1,6-hexane diisocyanate (HDI), 1,6-hexane diisocyanate dimer (HDI dimer), xylylene diisocyanate (XDI), α,α,α′,α′-tetramethylxylylene diisocyanate (TMXDI), trimethyl hexane diisocyanate (TMHDI) and mixtures thereof.

12. The process as claimed in claim 11, wherein when the aliphatic diisocyanate is isophorone diisocyanate (IPDI), water dispersion is carried out at about 30° C. to 40° C.

13. The process as claimed in claim 11, wherein when the aliphatic diisocyanate is 1,6-hexane diisocyanate (HDI), water dispersion is carried out at about 20° C. to 30° C.

14. The process as claimed in claim 1, wherein said aromatic diisocyanate is 10 to 40 mol % of the total amount of the diisocyanates.

15. The process as claimed in claim 1, wherein the neutralizing agent is selected from the group consisting of triethyl amine, ammonium hydroxide, sodium hydroxide, potassium hydroxide, and mixtures thereof.

16. The process as claimed in claim 1, wherein the chain extender is selected from the group consisting of ethylene diamine, butylene diamine, hexylene diamine, isophorone diamine, p-phenylene diamine, m-xylylene-α,α′-diamine, p-xylylene-α,α′-diamine, oligo(alkylene)ether diamine with a molecular weight of 100-250, 1,4-cyclohexanedimethanamine, 1,3-cyclohexanedimethanamine, meta-phenylenediamine (mPDA), trans/cis-(1,4-cyclohexanediamine), [R,S]/[R,R]-(1,3-cyclohexanediamine), trans-(4-aminomethyl-1-cyclohexanamine), 3-(aminomethyl)cyclohexylamine, 2,5-norbornanebis(methylamine), 2,6-norbornanebis(methylamine), and mixtures thereof.

17. The process as claimed in claim 16, wherein oligo(alkylene)ether diamine is consisting of:
(1) repeat units, which are selected from the group consisting of oxyethylene, oxypropylene, oxybutylene, and mixtures thereof; and
(2) alkyl amine end groups, which are selected from the group consisting of ethylene amine, propylene amine, butylene amine, and mixtures thereof.

18. The process as claimed in claim 16, wherein said chain extender is selected from the group consisting of ethylene glycol bis(2-aminoethyl)ether(triethylene glycol diamine, CAS#929-59-9), diethylene glycol bis(2-aminoethyl)ether(tetraethylene glycol diamine), diethylene glycol dipropyl amine, and mixtures thereof.

19. The process as claimed in claim 1, wherein said equivalent ratio of the hydrophilic component to the neutralizing agent is 0.9-1.1.

20. The process as claimed in claim 1, wherein said cross-linking agent is amine having three functional groups, and an amino equivalent of the cross-linking agent is 3%-25% of the total amino equivalent.

21. The process as claimed in claim 1, wherein step (1) comprises: mixing the hydrophilic component with the water-soluble solvent with a boiling point between 50° C. and 80° C. to form a mixture, adding an aromatic diisocyanate and an aliphatic diisocyanate to the mixture simultaneously, and adding a long-chain polyol to form prepolymers.

22. The process as claimed in claim 1, wherein step (1) comprises: mixing the long-chain polyol with the water-soluble solvent with a boiling point between 50° C. and 80° C. to form a mixture, adding an aromatic diisocyanate and an aliphatic diisocyanate to the mixture simultaneously, and adding a hydrophilic component to form prepolymers.
